(19) United States
(12) Patent Application Publication
(10) Pub. No.: US 2024/0184630 A1
(43) Pub. Date: Jun. 6, 2024

(54) DEVICE AND METHOD WITH BATCH NORMALIZATION

(71) Applicants: Samsung Electronics Co., Ltd., Suwon-si (KR); Seoul National University R&DB Foundation, Seoul (KR)

(72) Inventors: Jung Ho AHN, Seoul (KR); Sun Jung LEE, Seoul (KR); Jae Wan CHOI, Seoul (KR); Seung Hwan HWANG, Seongnam-si (KR)

(73) Assignees: Samsung Electronics Co., Ltd., Suwon-si (KR); Seoul National University R&DB Foundation, Seoul (KR)

(21) Appl. No.: 18/526,603

(22) Filed: Dec. 1, 2023

(30) Foreign Application Priority Data
Dec. 2, 2022 (KR) 10-2022-0166618

(51) Int. Cl. G06F 9/50; G06F 5/01; G06F 15/80

(52) U.S. Cl. CPC G06F 9/5027; G06F 5/01; G06F 15/8046

(57) ABSTRACT

A device and method with batch normalization are provided. An accelerator includes: core modules, each core module including a respective plurality of cores configured to perform a first convolution operation using feature map data and a weight; local reduction operation modules adjacent to the respective core modules, each including a respective plurality of local reduction operators configured to perform a first local operation that obtains first local statistical values of the corresponding core module; a global reduction operation module configured to perform a first global operation that generates first global statistical values of the core module based on the first local statistical values of the core modules; and a normalization operation module configured to perform a first normalization operation on the feature map data based on the first global statistical values.

### CROSS-REFERENCE TO RELATED APPLICATIONS

This application claims the benefit under 35 USC § 119(a) of Korean Patent Application No. 10-2022-0166618, filed on Dec. 2, 2022, in the Korean Intellectual Property Office, the entire disclosure of which is incorporated herein by reference for all purposes.

### BACKGROUND

### 1. Field

The following description relates a device and method with batch normalization.

### 2. Description of Related Art

As the demand for artificial intelligence (AI) technology increases, the need for methods of increasing the throughput of neural networks included in AI models is increasing. For this purpose, various studies are being conducted to smoothly process the training of neural networks.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an accelerator includes: core modules, each core module including a respective plurality of cores configured to perform a first convolution operation using feature map data and a weight; local reduction operation modules adjacent to the respective core modules, each including a respective plurality of local reduction operators configured to perform a first local operation that obtains first local statistical values of the corresponding core module; a global reduction operation module configured to perform a first global operation that generates first global statistical values of the core module based on the first local statistical values of the core modules; and a normalization operation module configured to perform a first normalization operation on the feature map data based on the first global statistical values.

Each local reduction operation module may be configured to generate a local mean value of the feature map data and a local square mean value of the feature map data, based on a result of the first convolution operation from the corresponding core module.

The global reduction operation module may be further configured to generate a mean of the feature map data, a variance of the feature map data, a first parameter value necessary for a normalization operation, and a second parameter value necessary for the normalization operation, based on the local mean value of the feature map data and the local square mean value of the feature map data.

The normalization operation module may be further configured to perform a normalization operation on the feature map data and perform an activation operation on the feature map data, based on the mean of the feature map data, the variance of the feature map data, the first parameter value necessary for the normalization operation, and the second parameter value necessary for the normalization operation.

A first static random access memory (SRAM) may be adjacent to the cores modules and function as level-1 cache therefor; and second SRAM may be adjacent to the local reduction operation modules and function as level-2 cache therefor.

Dynamic random access memory (DRAM) may be disposed adjacent to the global reduction operation module and the normalization operation module and may be configured to store a result of the first convolution operation.

The core modules may be interconnected to form a systolic array structure.

The local reduction operation module may be further configured to obtain the first local statistical values from each of the core modules in parallel.

The global reduction operation module may be further configured to obtain the first global statistical values of the core module in series.

Each core module may be further configured to perform a second convolution operation using an output result and a weight, the local reduction operation module may be further configured to perform a second local operation that obtains second local statistical values of the core modules based on a result of the second convolution operation, the global reduction operation module may be further configured to perform a second global operation that obtains second global statistical values of the core modules based on the second local statistical values of the core module, and the normalization operation module may be further configured to perform a second normalization operation on the feature map data based on the second global statistical values.

The local reduction operation module may be further configured to: perform an activation operation on the result of the second convolution operation; and obtain a sum of variation values of a local first parameter of the feature map data and a sum of variation values of a local second parameter of the feature map data.

The global reduction operation module may be further configured to obtain a variation value of a first parameter of the feature map data and a variation value of a second parameter of the feature map data, based on the sum of the variation values of the local first parameter of the feature map data and the sum of the variation values of the local second parameter of the feature map data.

The normalization operation module may be further configured to perform a second normalization operation on the feature map data, based on a mean of the feature map data, a variance of the feature map data, a value of the second parameter, the variation value of the first parameter, and the variation value of the second parameter.

The local reduction operation module may be further configured to obtain the second local statistical values of the core modules in parallel.

The global reduction operation module may be further configured to obtain the second global statistical values of the core modules in series.

The local reduction operation module may be further configured to obtain the second local statistical values based on a result of the first normalization operation.

In another general aspect, an electronic device includes: one or more processors; a memory storing instructions configured to cause the one or more processors to: perform a first convolution operation using feature map data and a weight; perform first local operations that generate first local statistical values of respective core modules based on results of the core modules performing the first convolution operation; perform a first global operation that generates first global statistical values based on the first local statistical values; and perform a first normalization operation on the feature map data based on the first global statistical values.

The instructions may be further configured to cause the one or more processors to: perform a second convolution operation using an output result and a weight; perform a second local operation that obtains second local statistical values of the core modules based on a result of the second convolution operation; perform a second global operation that obtains second global statistical values of the core modules based on the second local statistical values of the core modules; and perform a second normalization operation on the feature map data based on the second global statistical values.

In another general aspect, a method includes: performing a first convolution operation using feature map data and a weight; performing a first local operation that generates first local statistical values for each of multiple cores on which the first convolution operation is performed, based on a result of the first convolution operation; performing a first global operation that obtains first global statistical values based on the first local statistical values for each core; and performing a first normalization operation that is configured to perform a normalization operation on the feature map data based on the first global statistical values.

Any of the methods may be performed as part of a batch normalization fission-n-fusion (BNFF) process.

Other features and aspects will be apparent from the following detailed description, the drawings, and the claims.

### BRIEF DESCRIPTION OF THE DRAWINGS

FIG. 1 illustrates an example electronic device for accelerating a batch normalization operation.

FIG. 2 illustrates an example of a neural network.

FIG. 3 illustrates an example configuration of an electronic device for accelerating a batch normalization operation.

FIGS. 4A and 4B illustrate examples of a forward propagation operation and a backward propagation operation in a batch normalization layer according to a related art.

FIGS. 5A and 5B illustrate examples of a forward propagation operation and a backward propagation operation in a batch normalization layer in an electronic device for accelerating a batch normalization operation.

FIG. 6 illustrates an example forward propagation operation in an electronic device for accelerating a batch normalization operation.

FIG. 7 illustrates an example of an operation of components during a backward propagation operation in an electronic device for accelerating a batch normalization operation.

FIG. 8 illustrates example operations of a method of accelerating a batch normalization operation.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Batch normalization may refer to a normalization using a mean and a variance for each batch of an overall task even when data has various distributions for each batch unit when training a neural network. A batch normalization layer may perform an operation to change a data distribution of a feature map into a standard deviation and may be used when configuring a building block of a deep neural network (DNN) model.

Since batch normalization includes a reduction operation and a normalization operation, a large number of off-chip memory accesses may occur during a forward error propagation operation and a backward error propagation operation. An accelerator that optimizes off-chip memory access and optimizes an operation of a normalization layer to reduce the amount of computations and improve training performance may reduce the off-chip memory access of the normalization layer, but may have a low scalability.

Described herein are examples of an accelerator having a many-core structure with high scalability yet has fewer off-chip memory accesses of the normalization layer in a DNN accelerator environment.

Embodiments described herein may implement (or be implemented as part of) a batch normalization fission-n-fusion (BNFF) algorithm for optimizing off-chip memory accesses.

FIG. 1 illustrates an example electronic device for accelerating a batch normalization operation.

Referring to FIG. 1, an electronic device 100 may include a host processor 110, an off-chip memory 120, a memory controller 130, and an accelerator 140. The host processor 110, the off-chip memory 120, the memory controller 130, and the accelerator 140 may communicate with one another through a bus, a network on a chip (NoC), a peripheral component interconnect express (PCIe), and the like. The electronic device 100 may include, for example, various computing devices such as a mobile phone, a smartphone, a tablet, an e-book device, a laptop, a personal computer (PC), and a server, various wearable devices such as a smart watch, smart eyeglasses, a head mounted display (HMD), or smart clothes, various home appliances such as a smart speaker, a smart television (TV), and a smart refrigerator, and other devices such as a smart vehicle, a smart kiosk, an Internet of things (IoT) device, a walking assist device (WAD), a drone, a robot, and the like.

The host processor 110 may be configured to control respective operations of components included in the electronic device 100 and may be, for example, a central processing unit (CPU), but is not limited thereto. The host processor 110 may control operations performed by the electronic device 100. The host processor 110 may receive a request for processing the neural network in the accelerator 140, generate a kernel including instructions executable in the accelerator 140 in response to the received request, and transfer the generated kernel to the accelerator 140. The request may be made for a neural network-based data inference, and may be for obtaining a result of the data inference by allowing the accelerator 140 to execute the neural network for object recognition, pattern recognition, computer vision, speech recognition, machine translation, machine interpretation, recommendation services, personalized services, image processing, autonomous driving, or the like.

The off-chip memory 120 may be a memory disposed outside of the accelerator 140, and may include, for example, dynamic random access memory (DRAM), high bandwidth memory (HBM), and the like used as a main/host memory of the electronic device 100, but is not limited thereto. The off-chip memory 120 may store inference target data and/or parameters of the neural network to be executed in the accelerator 140, and data stored in the off-chip memory 120 may be transferred to the accelerator 140 for an inference. The off-chip memory 120 may also be used in a case in which capacity of an on-chip memory inside the accelerator 140 is insufficient to execute the neural network in the accelerator 140.

The off-chip memory 120 may have a greater memory capacity than the on-chip memory inside the accelerator 140. However, when the neural network is being executed, the cost for the accelerator 140 accessing the off-chip memory 120 may be greater than the cost for the accelerator 140 accessing its internal on-chip memory. Such a memory access cost may increase the amount of power and/or time that is required for accessing a memory and then reading or writing data from or in the memory.

The accelerator 140 may be an artificial intelligence (AI) accelerator that infers data by executing a neural network based on a corresponding kernel transmitted from the host processor 110. The accelerator 140 may be a separate processor distinguished from the host processor 110 (e.g., may be accessed via a bus interface). For example, the accelerator 140 may be a neural processing unit (NPU), a graphics processing unit (GPU), a tensor processing unit (TPU), a digital signal processor (DSP), and a CPU, but is not limited thereto.

The accelerator 140 may more effectively process certain tasks or workloads, which may be offloaded to the accelerator 140 by the host processor 110 (the host processor 110 being used for general purposes based on the characteristics of operations of the neural network). Here, at least one processing element (PE) in the accelerator 140 and the on-chip memory may be used. The on-chip memory in the accelerator 140 may include a global shared buffer and/or a local buffer that stores data required to perform operations of the accelerator 140 included in the accelerator 140 or a result of operations, and may be distinguished from the off-chip memory 120 located outside the accelerator 140. The on-chip memory may include, for example, a scratchpad memory accessible through an address space, static random-access memory (SRAM), and the like but is not limited thereto.

The neural network may provide an optimal output corresponding to an input by mapping an input and an output in a non-linear relationship, based on deep learning. The deep learning is a machine learning technique for solving given problems from a big data set, and is a process of optimizing the neural network by finding parameters (for example, weights) or a model that represents a structure of the neural network. The neural network may include a plurality of layers (e.g., an input layer, a plurality of hidden layers, and an output layer). Each of the layers may include a plurality of nodes each referred to as an artificial neuron. Each node denotes a computation unit having at least one input and an output, and nodes are connected to each other. A weight may be set for a connection between nodes and be adjusted or changed. The weight may determine the influence of a related data value on a final result by increasing, decreasing, or maintaining the data value. To each node included in the output layer, weighted inputs of nodes included in a previous layer may be input. A process of inputting weighted data from an arbitrary layer to the next layer is referred to as propagation. The neural network described herein may also be referred to as a model for the convenience of description.

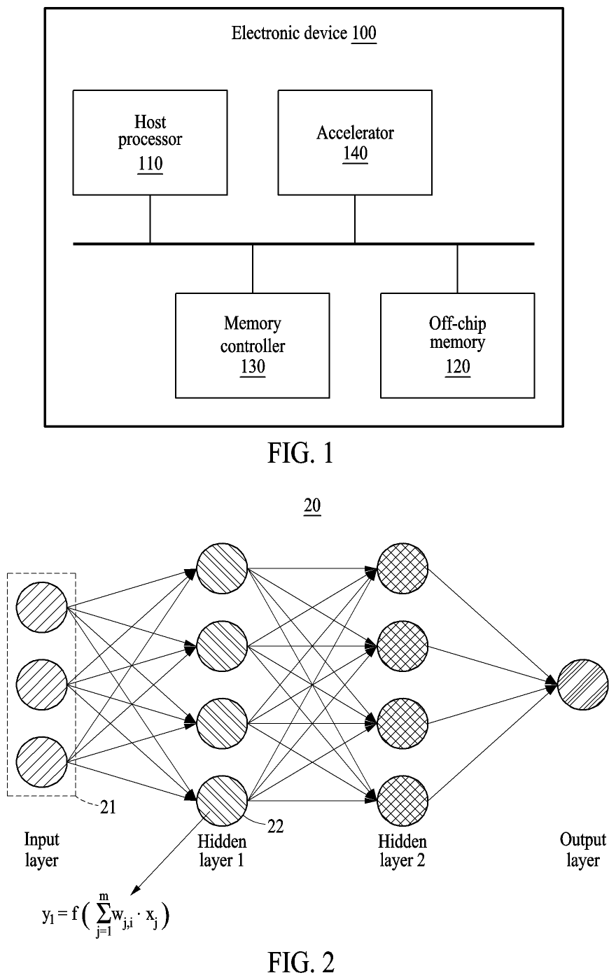

FIG. 2 illustrates an example of a neural network.

Referring to FIG. 2, a neural network 20 may correspond to a DNN. For the convenience of description, the neural network 20 is illustrated as including two hidden layers, but may include various numbers of hidden layers. In addition, in FIG. 2, although the neural network 20 is illustrated as including a separate input layer 21 to receive input data, the input data may be input directly to a hidden layer.

In the neural network 20, nodes of layers other than an output layer may be connected to nodes of a next layer via links to transmit output signals. Values obtained by multiplying node values of the nodes included in a previous layer by a weight assigned to each link may be input to one node via the links. The node values of the previous layer may correspond to linked values and the weights may correspond to node weights. A weight may be referred to as a parameter of the neural network 20. An activation function may include, for example, a sigmoid function, a hyperbolic tangent (Tanh) function, or a rectified linear unit (ReLU) function. A nonlinearity may be formed in the neural network 20 by the activation function.

An output of one arbitrary node 22 in the neural network 20 may be expressed by Equation 1.

$${y}_{i} = f ( {\sum }_{j = 1}^{m} {x}_{j , i} {x}_{j} ) \qquad Equation 1$$

Equation 1 denotes an output value yᵢ of the i-th node for m input values in an arbitrary layer. xⱼ denotes an output value of a j-th node of a previous layer, and w_{j,i} denotes a weight applied to a connector between the j-th node of the previous layer and the i-th node of a current layer. f( ) denotes an activation function. As shown in Equation 1, for the activation function, a multiplication cumulative result of the input value xⱼ and the weight w_{j,i} may be used. That is, an operation (i.e., a multiply and accumulate (MAC) operation) of multiplying and accumulating the appropriate input value xⱼ and the weight w_{j,i} at a desired time point may be repeated. In addition to these uses, there are various application fields requiring the MAC operation, and for this purpose, a processing device that may process the MAC operation in an analog circuit area may be used.

The neurons of the neural network may include a combination of weights or biases. The neural network may include one or more layers, each including one or more neurons or nodes. The neural network may infer a result from an arbitrary input by changing the weights of the neurons through training.

The neural network may include a DNN. The neural network may include a convolutional neural network (CNN), a recurrent neural network (RNN), a perceptron, a multilayer perceptron, a feed forward (FF), a radial basis function network (RBF), a deep feed forward (DFF), a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN).

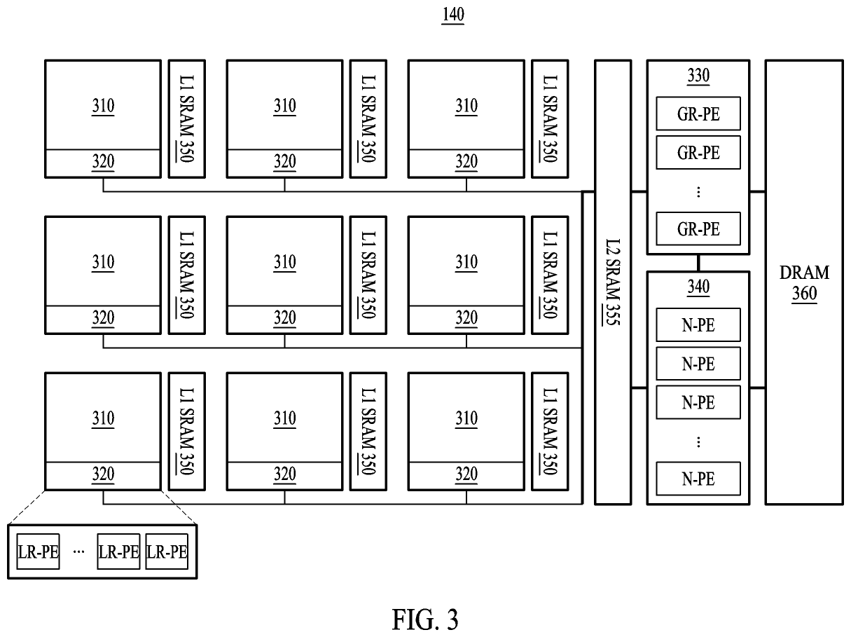

FIG. 3 illustrates an example configuration of an electronic device for accelerating the batch normalization operation.

Batch normalization may normalize a feature map distribution of each layer to be close to a standard normal distribution to prevent a distribution of an input feature map from being different for each layer during the training process of the neural network. The batch normalization of feature map data may be performed using four parameters; a mean of the feature map data, a variance of the feature map data, a shift parameter β, and a scale parameter γ. The batch normalization may include a forward propagation operation that calculates and stores variables in an order from an input layer to an output layer of a neural network model. The batch normalization may further include a backward propagation operation in which losses are calculated in an order from the output layer to the input layer of the neural network model and parameters are updated based on the calculated losses.

Referring to FIG. 3, the accelerator 140 of an electronic device (e.g., the electronic device 100 of FIG. 1) for accelerating the batch normalization operation may include a core modules 310 each having cores that perform a first convolution operation using the feature map data and the weight. A core module 310 may have a systolic array structure. The accelerator 140 may further include local reduction operation modules 320 adjacent to the respective core modules 310 and each including a respective plurality of local reduction operators for performing a first local operation that obtains first local statistical values of the corresponding core module 310. Here, the first local statistical values may be, for example, a local mean value of the feature map data or a local square mean value of the feature map data and may be defined as in Equation 2.

$$Local square mean = \frac{1}{N} {\sum }_{i = 1}^{N} {x}_{i}^{2} \\ Local mean = \frac{1}{N} {\sum }_{i = 1}^{N} {x}_{i} \qquad Equation 2$$

A local reduction operation module 320 may obtain the local mean value of the feature map data and the local square mean value of the feature map data, based on a result of the first convolution operation. A local reduction operation module 320 may obtain the first local statistical values of the respective core modules 310 in parallel.

The accelerator 140 may further include a global reduction operation module 330 performing a first global operation that obtains first global statistical values of the core modules 310 based on the first local statistical values of the core modules 310. Here, the first global statistical values may include a first parameter value and a second parameter value that may be used for the mean of the feature map data, the variance of the feature map data, and the normalization operation.

The global reduction operation module 330 may obtain the first global statistical values of the core module 310 in series, i.e., at different times.

The accelerator 140 may further include a normalization operation module 340 that performs a first normalization operation on the feature map data of the core modules 310 based on the first global statistical values of the core modules 310. The normalization operation module 340 may perform the normalization operation and an activation operation on the feature map data, based on the mean of the feature map data, the variance of the feature map data, the first parameter value necessary for the normalization operation, and the second parameter value necessary for the normalization operation. A normalization operation result through the normalization operation may be performed, for example, with instructions/circuitry configured as indicated by Equation 3 below.

$$First normalization operation result = γ \frac{{x}_{i} - μ}{\sqrt{{σ}^{2} + ϵ}} + β \qquad Equation 3$$

Here, β denotes a shift value that is the first parameter value, γ denotes a scale value that is the second parameter value, xᵢ denotes a feature map data value, μ denotes the mean of the feature map data, σ² denotes the variance of the feature map data, and ϵ denotes an arbitrary small number to prevent the denominator from being “0”.

The accelerator 140 may further include first SRAM 350 (e.g., level 1 (L1) cache) dispersed to be adjacent to the cores and second SRAM 355 (e.g., level 2 (L2) cache) adjacent to the local reduction operation modules 320. The accelerator 140 may further include DRAM 360 disposed adjacent to the global reduction operation module 330 and the normalization operation module 340 and for storing a first convolution operation result. As used herein with respect to accelerator components, “adjacent” means electrically connected without major components in between. For example, connected by wires, buses, or the like. “Adjacent” does not necessarily mean physical adjacency, rather “adjacent” refers to sufficiently small communication latency/overhead to allow caching functionality (in the case of memory “adjacency”).

Each core module 310 may perform a second convolution operation using an output result and the weight.

Each local reduction operation module 320 may perform a second local operation that obtains second local statistical values of the corresponding core module 310 based on a result of the second convolution operation. The local reduction operation module 320 may perform the activation operation on the result of the second convolution operation, and may obtain a sum of variation values of a local first parameter of the feature map data and a sum of variation values of a local second parameter of the feature map data. The sum of the variation values of the local first parameter of the feature map data and the sum of the variation values of the local second parameter of the feature map data may be obtained as, for example, with instructions/circuitry configured as indicated by Equation 4.

$$Sum of variation values of local first parameter = {\sum }_{i = 1}^{N} \partial {β}_{N} \\ Sum of variation values of local second parameter = {\sum }_{i = 1}^{N} \partial {γ}_{N} \qquad Equation 4$$

The global reduction operation module 330 may perform a second global operation that obtains second global statistical values of the core modules 310 based on the second local statistical values of the core modules 310. The global reduction operation module 330 may obtain a variation value of the first parameter of the feature map data and a variation value of the second parameter of the feature map data, based on the sum of the variation values of the local first parameter of the feature map data and on the sum of the variation values of the local second parameter of the feature map data.

The normalization operation module 340 may perform a second normalization operation on the feature map data based on the second global statistical values. The second normalization operation on the feature map data may be performed, for example, with instructions/circuitry configured as indicated by Equation 5.

$$Second normalization operation result = \frac{γ}{\sqrt{{σ}^{2} + ϵ}} ( \partial {y}_{i} - \frac{\partial {β}_{i}}{N} - \frac{{x}_{i} - μ}{N \sqrt{{σ}^{2} + ϵ}} \partial γ ) \qquad Equation 5$$

Here, N denotes the total number of pieces of data, yᵢ denotes an output result, β denotes the shift value that is the first parameter value, γ denotes the scale value that is the second parameter value, xᵢ denotes the feature map data value, μ denotes the mean of the feature map data, σ² denotes the variance of the feature map data, and ϵ denotes an arbitrary small number to prevent the denominator from being “0”.

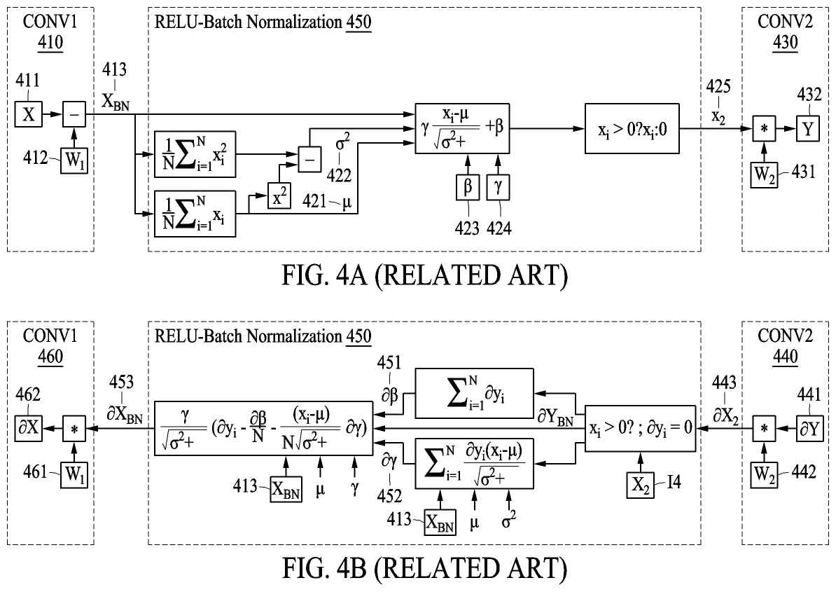

FIGS. 4A and 4B illustrate examples of operations of forward propagation and backward propagation in a batch normalization layer according to the related art.

Referring to FIG. 4A, an accelerator for training a neural network according to the related art may obtain a convolution operation result X_{BN} 413 of operation CONV1 410, which is performed using feature map data 411 and a weight 412 during the forward propagation operation for the batch normalization. The electronic device may calculate a mean 421 and a variance 422 of a channel direction based on the convolution operation result X_{BN} 413 in a batch normalization-active operation 450, and then may perform the normalization operation using the average 421 and the variance 422 of the channel direction, a first parameter β 423 (e.g., a shift parameter), and a second parameter γ 424 (e.g., a scale parameter). The electronic device may obtain an output result 432 using a normalization operation result 425 and a weight 431 in operation CONV2 430. To summarize in terms of performance, the neural network training device according to the related art may request three off-chip memory accesses (three off chip memory accesses obtained by multiplying two off chip memory accesses that read X_{BN}+one off chip memory access that writes X2 are required) in this forward propagation process.

Referring to FIG. 4B, the accelerator for training a neural network according to the related art may obtain a convolution operation result 443 of operation CONV2 440 using a variation 441 and a weight 442 of an output result during the backward propagation operation for the batch normalization. The training device may obtain a first parameter variation ∂β 451 for training the first parameter β 423 and a second parameter variation ∂γ 452 for training the second parameter γ 424 in an active-batch normalization operation 450, and may obtain a variation 453 of the convolution operation result X_{BN} 413 that is obtained during the forward propagation operation by performing the normalization operation. The training device may obtain a variation 462 of the feature map data as a result of the convolution operation in operation CONV1 460 using the variation 453 and a weight 461. The first parameter β 423 and the second parameter γ 424 may be trained in a batch normalization process, in terms of performance, the training device may request seven off-chip memory accesses—one off chip memory access that reads X2, one off chip memory access that reads ∂x, two off chip memory accesses that read X_{BN}, one off chip memory access that reads ∂Y_{BN}, one off chip memory access that writes ∂Y_{BN}, and one off chip memory access that writes ∂Y_{BN} are required.

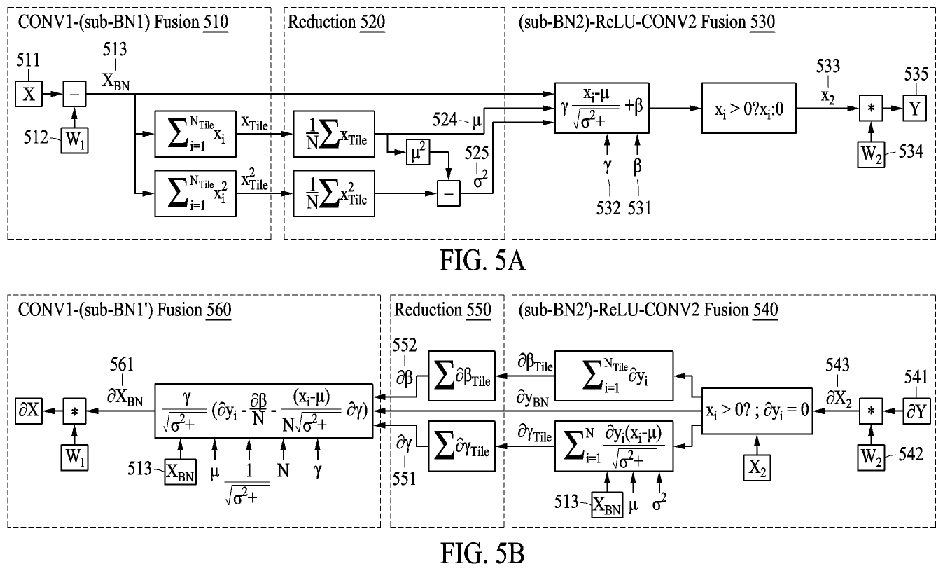

FIGS. 5A and 5B illustrate examples of operations of the forward propagation and the backward propagation in the batch normalization layer in the electronic device for accelerating the batch normalization operation, according to one or more embodiments.

The accelerator of the electronic device (e.g., the electronic device 100 of FIG. 1) for accelerating the batch normalization operation may perform the forward propagation operation and the backward propagation operation of the batch normalization operation through two reduction operations (a local reduction operation and a global reduction operation) and one normalization operation.

Referring to FIG. 5A, the electronic device may perform the first convolution operation in a first local operation 510 using feature map data 511 and a weight 512, and may thus obtain a first convolution operation result 513. The electronic device may obtain the local mean value of the feature map data and the local square mean value of the feature map data in a first global operation 520 based on the first convolution operation result 513, and may obtain a mean 524 of the feature map data and a variance 525 of the feature map data to be used for the batch normalization operation. The electronic device may perform the normalization operation using the mean 524 and the variance 525, a first parameter β 531 (e.g., a shift parameter), and a second parameter γ 532 (e.g., a scale parameter) in operation CONV2 530, and may perform the normalization operation based on the obtained mean 524 and the variance 525. The electronic device may obtain an output result 535 using a normalization operation result 533 and a weight 534 in operation CONV2 530. Comparing the off-chip memory access of the neural network training device of the related art to the off-chip memory access of the electronic device for accelerating the batch normalization operation, it may be seen that the latter has one access.

Referring to FIG. 5B, the electronic device for accelerating the batch normalization operation may obtain a convolution operation result 543 in operation CONV2 540 using a variation 541 and a weight 542 of an output result during the backward propagation operation for the batch normalization. In operation CONV2 540, the electronic device may perform the backward propagation operation of the activation function. In operation 550, the electronic device may perform the backward propagation operation of the activation function based on the convolution operation result 543. In operation 550, the electronic device may obtain a first parameter variation ∂β 552 (for training the first parameter β) and a second parameter variation ∂γ 551 (for training the second parameter γ). In operation 560, the electronic device may obtain a second normalization operation result 561 based on the first convolution operation result 513.

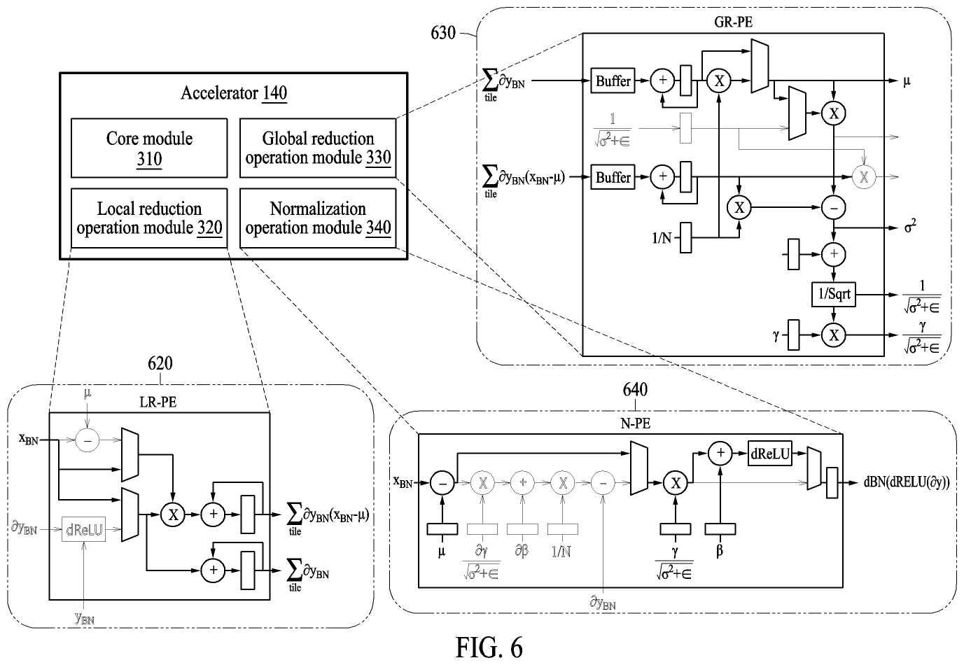

FIG. 6 illustrates an example of the forward propagation operation in the electronic device for accelerating the batch normalization operation.

Referring to FIG. 6, the accelerator 140 of the electronic device (e.g., the electronic device 100 of FIG. 1) may perform the first convolution operation using the feature map data and the weight through a core module 310. The result of the first convolution operation may be transmitted to (i) the local reduction operation module 320 adjacent to the core module 310 performing the first local operation and (ii) to the DRAM 360. The core module 310 may have a processing element in a systolic array structure.

The local reduction operation module 320 may obtain a sum of local values of the feature map data and a sum of local square values of the feature map data through the operation results of each core of the corresponding core module 310, and based on the sums, may obtain the local mean value of the feature map data and the local square mean value of the feature map data. The first local statistical values may include the local mean value of the feature map data and the local square mean value of the feature map data. Here, the number of operation results of each local reduction operation module 320 may be the same as the number of channels (columns) of the operation result of the core module 310. The local reduction operation modules 320 may each obtain their respective first local statistical values of the core module 310 in parallel. The operation in the local reduction operation module 320 may be the same as operation 620.

The accelerator 140 may perform the first global operation that obtains global statistical values of the respective core modules 310 based on the respective first local statistical values through the global reduction operation module 330. The global statistical values may include the mean and the variance of all feature map data. The global reduction operation module 330 may perform the first global operation to obtain the global statistical values of the core modules 310, and then may calculate values for the mean of all feature map data, the variance of all feature map data, and the normalization operation using N (where N is the number of batches×width×height of the feature map). The global reduction operation module 330 may obtain in series the global statistical values of the core module 310 for different times. The operation in the global reduction operation module 330 may be the same as operation 630.

The accelerator 140 may perform the first normalization operation on the feature map data necessary for a next convolution operation through the normalization operation module 340. The normalization operation module 340 may perform an activation operation/function (e.g., ReLU) of the feature map data. The operation result of the normalization operation module 340 may be simultaneously stored in the L1 SRAM (e.g., SRAM 350), the L2 SRAM (e.g., SRAM 355), and the DRAM 360, and the operation result may be used for the next convolution operation and the backward propagation operation. When the BNFF algorithm is applied to the accelerator 140 of the electronic device for accelerating the batch normalization operation according to the present disclosure, the off-chip memory access necessary for the batch normalization operation may be reduced from three accesses to one access, thereby reducing overall the operation time. The operation in the normalization operation module 340 may be the same as operation 640.

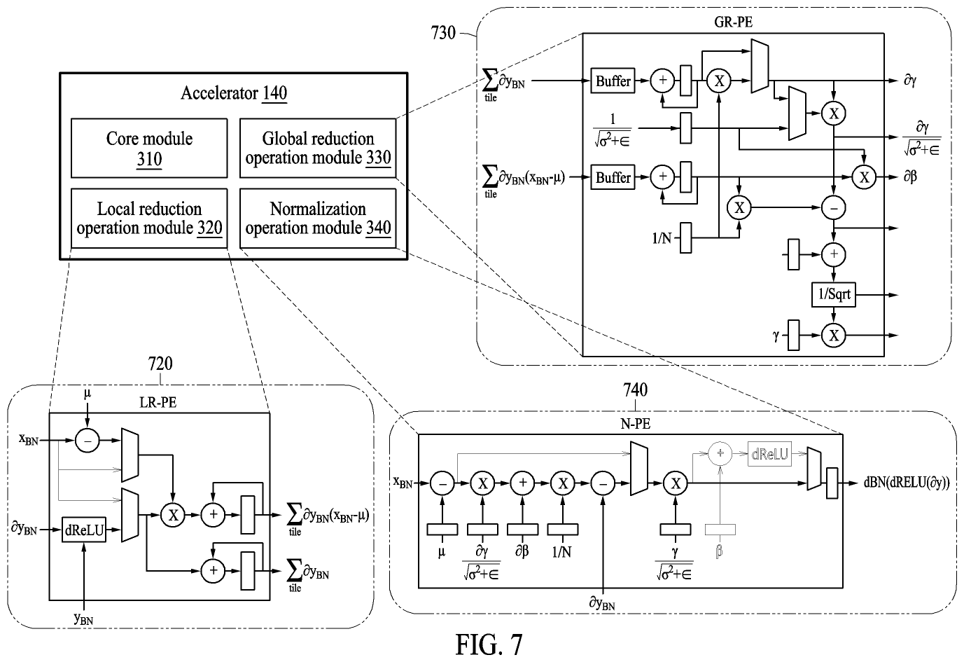

FIG. 7 illustrates an example of an operation of components of the accelerator 140 during the backward propagation operation.

Referring to FIG. 7, the accelerator 140 of the electronic device (e.g., the electronic device 100 of FIG. 1) may perform the second convolution operation using the output result and the weight through the core modules 310.

The accelerator 140 may perform the activation operation on the second convolution operation result through the local reduction operation modules 320 and perform the second local operation that obtains the second local statistical values of the respective core modules 310. The second local statistical values may include the sum of the variation values of the local first parameter of the corresponding core module 310 and the sum of the variation values of the local second parameter of the feature map data. Here, the local reduction operation module 320 may obtain the second local statistical values based on the first normalization operation result in the forward propagation operation. The operation in the local reduction operation module 320 may be the same as operation 720.

The accelerator 140 may obtain the variation value of the first parameter and the variation value of the second parameter of the feature map data, and may do so based on the sum of the variation values of the local first parameter and the sum of the variation values of the local second parameter of the feature map data, as performed through the global reduction operation module 330. The operations in the global reduction operation module 330 may be the same as operation 730.

The accelerator 140 may perform the second normalization operation of the feature map data based on (i) the mean of the feature map data, (ii) the variance of the feature map data, (iii) the second parameter value, (iv) the variation value of the first parameter, and (v) the variation value of the second parameter, and the second normalization may be performed through the normalization operation module 340. The operations in the normalization operation module 340 may be the same as operation 740.

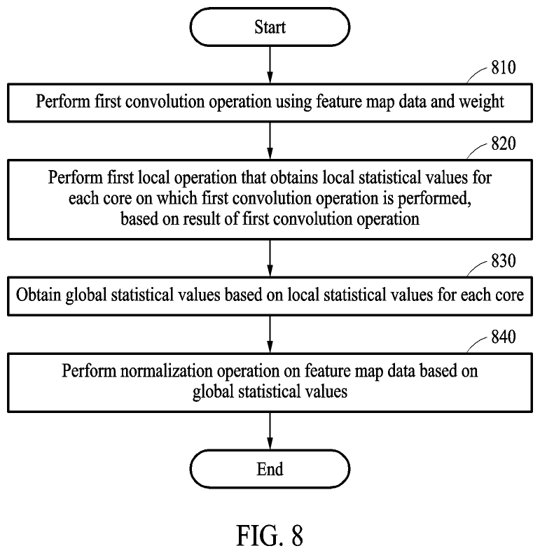

FIG. 8 illustrates example operations of a method of accelerating a batch normalization operation.

Referring to FIG. 8, in operation 810, an electronic device (e.g., the electronic device 100 of FIG. 1) may perform a first convolution operation using feature map data and a weight. The first convolution operation may be performed through the core modules 310 of FIG. 3.

In operation 820, the electronic device may perform a first local operation that obtains first local statistical values of the respective core modules 310 in which the first convolution operation is performed, based on the result of the first convolution operation. The first local operation may be performed through the local reduction operation module 320 of FIG. 3.

In operation 830, the electronic device may obtain first global statistical values based on the local statistical values for each core of each core module 310. The first global statistical values may be obtained through the global reduction operation modules 330 of FIG. 3.

In operation 840, the electronic device may perform a first normalization operation on the feature map data based on the first global statistical values. The normalization operation may be performed through the normalization operation module 340 of FIG. 3.

After completing the forward propagation operation in operations 810 to 840, the electronic device may perform the backward propagation operation. The performing of the backward propagation operation may be the same as that of the backward propagation operation in each of the core module 310, the local operation module 320, the global reduction operation module 330, and the normalization operation module 340 in the description of FIG. 3.

The computing apparatuses, the vehicles, the electronic devices, the processors, the memories, the accelerators, the information output system and hardware, the storage devices, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RW, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An accelerator comprising:
core modules, each core module comprising a respective plurality of cores configured to perform a first convolution operation using feature map data and a weight;
local reduction operation modules adjacent to the respective core modules, each comprising a respective plurality of local reduction operators configured to perform a first local operation that obtains first local statistical values of the corresponding core module;
a global reduction operation module configured to perform a first global operation that generates first global statistical values of the core module based on the first local statistical values of the core modules; and
a normalization operation module configured to perform a first normalization operation on the feature map data based on the first global statistical values.

2. The accelerator of claim 1, wherein each local reduction operation module is configured to generate a local mean value of the feature map data and a local square mean value of the feature map data, based on a result of the first convolution operation from the corresponding core module.

3. The accelerator of claim 2, wherein the global reduction operation module is further configured to generate a mean of the feature map data, a variance of the feature map data, a first parameter value necessary for a normalization operation, and a second parameter value necessary for the normalization operation, based on the local mean value of the feature map data and the local square mean value of the feature map data.

4. The accelerator of claim 3, wherein the normalization operation module is further configured to perform a normalization operation on the feature map data and perform an activation operation on the feature map data, based on the mean of the feature map data, the variance of the feature map data, the first parameter value necessary for the normalization operation, and the second parameter value necessary for the normalization operation.

5. The accelerator of claim 1, further comprising:
first static random access memory (SRAM) adjacent to the core modules and function as level-1 cache therefor; and
second SRAM adjacent to the local reduction operation modules and function as level-2 cache therefor.

6. The accelerator of claim 1, further comprising:
dynamic random access memory (DRAM) disposed adjacent to the global reduction operation module and the normalization operation module and configured to store a result of the first convolution operation.

7. The accelerator of claim 1, wherein the core modules are interconnected to form a systolic array structure.

8. The accelerator of claim 1, wherein the local reduction operation module is further configured to obtain the first local statistical values from each of the core modules in parallel.

9. The accelerator of claim 1, wherein the global reduction operation module is further configured to obtain the first global statistical values of the core module in series.

10. The accelerator of claim 1, wherein
each core module is further configured to perform a second convolution operation using an output result and a weight,
the local reduction operation module is further configured to perform a second local operation that obtains second local statistical values of the core modules based on a result of the second convolution operation,
the global reduction operation module is further configured to perform a second global operation that obtains second global statistical values of the core modules based on the second local statistical values of the core module, and
the normalization operation module is further configured to perform a second normalization operation on the feature map data based on the second global statistical values.

11. The accelerator of claim 10, wherein the local reduction operation module is further configured to:
perform an activation operation on the result of the second convolution operation; and
obtain a sum of variation values of a local first parameter of the feature map data and a sum of variation values of a local second parameter of the feature map data.

12. The accelerator of claim 11, wherein the global reduction operation module is further configured to obtain a variation value of a first parameter of the feature map data and a variation value of a second parameter of the feature map data, based on the sum of the variation values of the local first parameter of the feature map data and the sum of the variation values of the local second parameter of the feature map data.

13. The accelerator of claim 12, wherein the normalization operation module is further configured to perform a second normalization operation on the feature map data, based on a mean of the feature map data, a variance of the feature map data, a value of the second parameter, the variation value of the first parameter, and the variation value of the second parameter.

14. The accelerator of claim 10, wherein the local reduction operation module is further configured to obtain the second local statistical values of the core modules in parallel.

15. The accelerator of claim 10, wherein the global reduction operation module is further configured to obtain the second global statistical values of the core modules in series.

16. The accelerator of claim 10, wherein the local reduction operation module is further configured to obtain the second local statistical values based on a result of the first normalization operation.

17. An electronic device comprising:
one or more processors;
a memory storing instructions configured to cause the one or more processors to:
perform a first convolution operation using feature map data and a weight;
perform first local operations that generate first local statistical values of respective core modules based on results of the core modules performing the first convolution operation;
perform a first global operation that generates first global statistical values based on the first local statistical values; and
perform a first normalization operation on the feature map data based on the first global statistical values.

18. The electronic device of claim 17, wherein the instructions are further configured to cause the one or more processors to:
perform a second convolution operation using an output result and a weight;
perform a second local operation that obtains second local statistical values of the core modules based on a result of the second convolution operation;
perform a second global operation that obtains second global statistical values of the core modules based on the second local statistical values of the core modules; and
perform a second normalization operation on the feature map data based on the second global statistical values.

19. A method comprising:
performing a first convolution operation using feature map data and a weight;
performing a first local operation that generates first local statistical values for each of multiple cores on which the first convolution operation is performed, based on a result of the first convolution operation;
performing a first global operation that obtains first global statistical values based on the first local statistical values for each core; and
performing a first normalization operation that is configured to perform a normalization operation on the feature map data based on the first global statistical values.

20. The method of claim 19, wherein the method is performed as part of a batch normalization fission-n-fusion (BNFF) process.
